(19) United States
(12) Patent Application Publication
(10) Pub. No.: US 2022/0092142 A1
(43) Pub. Date: Mar. 24, 2022

(54) SYSTEM AND METHOD FOR STORING AND RETRIEVING INFORMATION

(71) Applicant: Kamaldeep Singh Mann, Delta (CA)

(72) Inventor: Kamaldeep Singh Mann, Delta (CA)

(21) Appl. No.: 17/028,556

(22) Filed: Sep. 22, 2020

(51) Int. Cl. G06F 16/955; G06K 7/14

(52) U.S. Cl. CPC G06F 16/9554; G06K 7/1417

(57) ABSTRACT

A system is provided whereby information is associated with a unique optical code, the information is transmitted wirelessly over the Internet to a cloud-based storage device and the information is subsequently retrieved in response to a query utilizing said unique optical code.

### BACKGROUND OF THE INVENTION

Computer readable codes such as barcode and QR codes have greatly enhanced the speed in exchange of information.

A barcode is a well-recognized feature on a cast array of products that are used in a method of representing data in a visual, machine-readable form. The initially used bar codes are commonly referred to as linear or one-dimensional (1D), can be scanned by special optical scanners, called barcode readers.

AS the barcode technology developed, two-dimensional (2D) variants using rectangles, dots, hexagons and other geometric patterns, called matrix codes or 2D barcodes, were established.

Although they do not use bars, 2D barcodes can be readable with optical computer-based readers.

The Quick Response Code, known as a QR Code, is a well-recognized matrix bar code. A barcode is a machine-readable optical label that contains information about the item to which it is attached. In practice, QR codes often contain data for a locator, identifier, or tracker that typically points to a website or application.

While many commercial entities have made use of optical bar and QR codes to direct users to a particular website or mobile computing application, or, for sales and inventory, there is a novel method including optical codes that has yet to be explored.

Optical codes are capable of providing personal filing and storage of information.

The present invention utilizes this method and fulfills a great need.

### SUMMARY OF THE INVENTION

As used herein, the term optical codes will identify a bar code, QR code, computer readable indicia including indicia viewed only in visible light by a user and indicia that is only readable using an ultraviolet or infrared computer based optical reading device, or combinations of any of these. In the embodiments utilizing optical codes only readable using an ultraviolet or infrared computer based optical reading device, a user will appear to see a blank area with indicia to scan.

Individuals often find themselves in situations where they desire to prepare and store still photographs, video, text, and other information where it is readily retrievable.

Current methods do not provide a seamless and stepwise configuration that is easily utilized.

In one non-limiting example, a consumer purchases an item requiring assembly. In utilizing the system of the present invention, photos, videos, instructions, web links, and the like, are captured with a handheld computing device and the capture data associated with a unique QR code. This unique QR code is a fixed to said item and provides a virtual file that is easily retrievable upon scanning the QR Code.

In one embodiment of the present invention, scannable optical code stickers are provided, which allows the consumer to upload and store files and access these files in the future when that specific sticker is scanned.

The scannable optical code stickers have pre-printed unique codes (e.g. QR code technology) to allow the consumer to purchase these stickers and then scan the code and upload specific electronic files to that specific sticker/code. The sticker is then placed wherever (at a location or on an item), for whenever it needs to be accessed for the future. When these files need to be accessed, the consumer simply scans the specific code to be given access. These electronic files include, but are not limited to: pictures, videos, documents, web link files, or combinations thereof.

The invention further includes providing an application for mobile computing devices and a cloud-based storage system for the transmission of associated information.

Several novel aspects of the invention include:

1) To provide the ability to store specific electronic files to any physical location;

2) To provide an easy-to-use App that provides the platform to scan stickers and upload/access stored files; and

3) To provide a cloud-based storing system to store consumer files.

In one embodiment, the present invention is a system for personalized storage and retrieval of information, said system comprising:
a handheld computer device constructed and arranged to transmit and receive information wirelessly over the Internet and further constructed with a configuration for reading an optical code;
a mobile computing application operatively associated with said handheld computer device;
a pre-printed optical code on a computer readable surface;
information captured by said handheld computer device and associated with said pre-printed optical code;
a cloud-based information storage system constructed to receive said information captured by said handheld computer device and to transmit said information captured by said handheld computer device in response to a query utilizing said information associated with said pre-printed optical code.

In one embodiment, the present invention is a system for personalized storage and retrieval of information, said system comprising:
a handheld computer device constructed and arranged to transmit and receive information wirelessly over the Internet and further constructed with a configuration for reading an optical code;
a mobile computing application operatively associated with said handheld computer device;
a user created and/or user generated optical code on a computer readable surface;
information captured by said handheld computer device and associated with said pre-printed optical code;
a cloud-based information storage system constructed to receive said information captured by said handheld computer device and to transmit said information captured by said handheld computer device in response to a query utilizing said information associated with said pre-printed optical code.

In one embodiment, the handheld computing device is a cell phone, smart phone, or tablet computer.

In one embodiment, the pre-printed optical code is provided as one or more stickers each with a pre-printed QR code wherein each sticker has a first side printed with said QR code and an opposite side having adhesive disposed thereon.

In one embodiment, the information captured by said handheld computer device is audio, video, text, web links, or combinations thereof.

In one embodiment, the present invention is a method of storing and retrieving information, said method comprising the steps of:
providing a system as disclosed herein;
capturing information with said handheld computing device;
associating said captured information with a unique optical code utilizing said mobile computing application;
transmitting said associated information to a cloud-based storage device where said information is stored with said unique optical code;
retrieving said associated information from said cloud-based storage device by sending a query with said unique QR code to said cloud-based storage device and said retrieved information is transmitted to said handheld computer device.

In one embodiment, the present invention is a system for personalized storage and retrieval of information, said system comprising:
a handheld computer device constructed and arranged to transmit and receive information wirelessly over the Internet and further constructed with a configuration for reading a QR code;
a mobile computing application operatively associated with said handheld computer device;
a pre-printed QR code on a computer readable surface;
information captured by said handheld computer device and associated with said pre-printed optical code;
a cloud-based information storage system constructed to receive said information captured by said handheld computer device and to transmit said information captured by said handheld computer device in response to a query utilizing said information associated with said pre-printed QR code.

In one embodiment, the handheld computing device is a cell phone, smart phone, or tablet computer.

In one embodiment, the pre-printed QR code is provided as one or more stickers each with a pre-printed QR code wherein each sticker has a first side printed with said QR code and an opposite side having adhesive disposed thereon.

In one embodiment, the information captured by said handheld computer device is audio, video, text, web links, or combinations thereof.

In one embodiment, the present invention is a method of storing and retrieving information, said method comprising the steps of:
providing a system as disclosed herein;
capturing information with said handheld computing device;
associating said captured information with a unique QR code utilizing said mobile computing application;
transmitting said associated information to a cloud-based storage device where said information is stored with said unique QR code;
retrieving said associated information from said cloud-based storage device by sending a query with said unique QR code to said cloud-based storage device and said retrieved information is transmitted to said handheld computer device.

### BRIEF DESCRIPTION OF THE SEVERAL VIEWS OF THE DRAWINGS

FIG. 1 is a flowchart of the method steps according to one embodiment of the present invention.

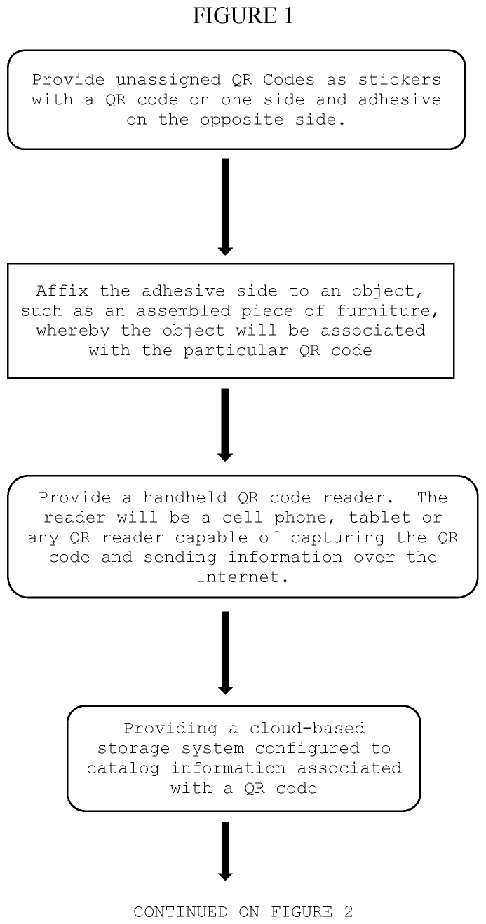

FIG. 2 is a flowchart continuation from FIG. 1 of the method steps according to one embodiment of the present invention.

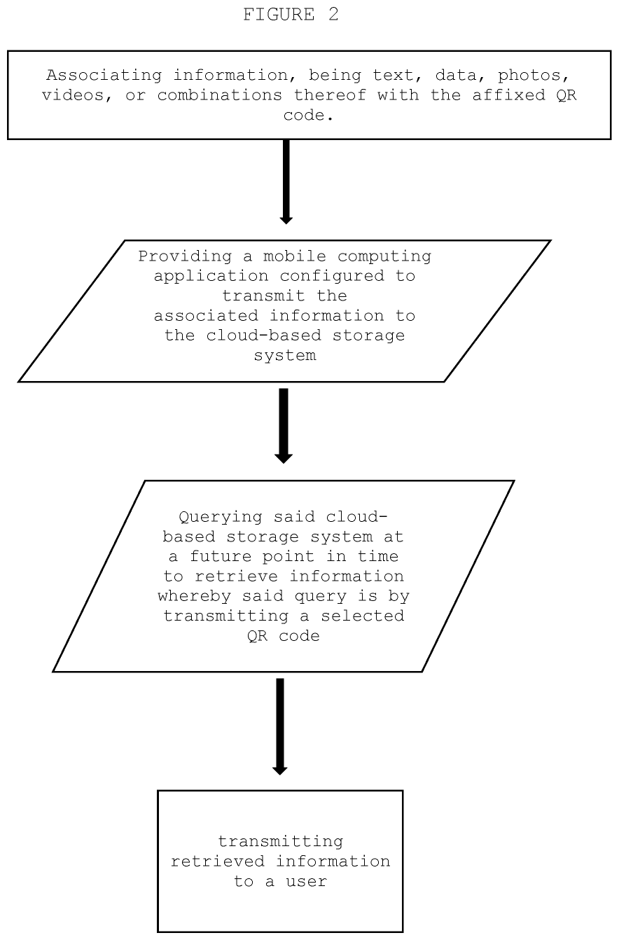

### DETAILED DESCRIPTION OF THE PREFERRED EMBODIMENT

The present invention provides a novel system and method whereby personal information is associated with a unique optical code. The individual can store and retrieve the information seamlessly by utilizing a handheld computer device configured with hardware having the configuration to read an optical code. The handheld computing device further has hardware for running a mobile computing application and for the input and output of information wirelessly over the Internet. The system and method of the present invention will further include a cloud-based storage system whereby a user uploads information associated with an optical code and information is downloaded to a handheld computer device based on a query utilizing an optical code.

As demonstrated in the figures, the steps of the invention in one embodiment are as follows:

The system and method of the present invention begins with unassigned optical codes provided as stickers with optical code on one side and adhesive on the opposite side.

The user will affix the adhesive side to an object, such as an assembled piece of furniture, whereby the object will be associated with the particular optical code.

The user will utilize a handheld computing device configured with an optical code reader. The handheld computing device configured with an optical code reader will be a cell phone, smart phone, tablet or any handheld computing device with an optical reader capable of capturing the optical code and sending/receiving information over the Internet.

The system and method of the present invention further includes providing a cloud-based storage system device configured to receive information associated with an optical code, catalog information associated with an optical code, and transmit information in response to a query associated with an optical code.

The associating information includes, text, data, photos, videos, web links, or combinations thereof with the affixed optical code.

The mobile computing application accessed with a mobile computing device is configured to transmit the associated information to the cloud-based storage system.

When a user desires to retrieve the information, the user will query said cloud-based storage system at a future point in time to retrieve information whereby said query is by transmitting a selected QR code.

In one embodiment, a user is either the person who created and stored the information or a different person provided access to the stored information.

In response to the query the cloud-based storage system will transmit retrieved information to a user.

In a related use, wherein the technology of the present invention is configured to assist the owners and or managers of short-term rental properties. An optical code is positioned at the entrance to a property. A particular user is provided a passcode to a wireless handheld computing device. That passcode provides access to the information operatively associated with the particular optical code. In this embodiment, entrance lock is associated with the optical code positioned within proximity to the entrance. The user, and utilizing their passcode, will scan the optical code and be directed to information relating to unlocking the entrance lock.

The owner or manager of the property is able to remotely change the entrance passcode with each subsequent customer. Once the passcode is changed, the code that provided access to information associated with the optical code will no longer be operable.

In this embodiment, the system and method includes:

An optical code physically in proximity to a locked entranceway;

a handheld computing device utilized by a short-term resident configured with Internet access and hardware to read said optical code;

a system controlled by an owner or manager configured for communicating a passcode to said handheld computing device;

said system controlled by an owner or manager further configured to remotely change an entranceway lock access, wherein said system further is configured to communicate an access code to said handheld computing device and said access code allows said handheld computing device to retrieve entranceway lock information associated with said optical code;

Once said access code associates with said optical code, information relating to unlocking the entranceway is transmitted to the handheld computer device.

Not only does this system provide a more secure configuration for securing the locking entranceway of a particular location, but, in the event that the handheld computing device is lost or stolen, the system can immediately lock the door remotely and change the unlock parameters.

In one embodiment, the system and method includes:

An optical code operatively associated with stored data; a computing device utilized by an approved user and said computing device is configured with Internet access and hardware to read said optical code;

a system controlled by an owner of said associated stored data;

the owner of said information associated with said optical code provides access to the data based on a unique identifier including, but not limited to, an e-mail address, cell phone number, IP address, computer application account identifier, combinations thereof, and the like;

Once said access code associates with said optical code, information is transmitted to the computer device.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A system for personalized storage and retrieval of information, said system comprising:
a handheld computer device constructed and arranged to transmit and receive information wirelessly over the Internet and further constructed with a configuration for reading an optical code;
a mobile computing application operatively associated with said handheld computer device;
a pre-printed optical code on a computer readable surface;
information captured by said handheld computer device and associated with said pre-printed optical code;
a cloud-based information storage system constructed to receive said information captured by said handheld computer device and to transmit said information captured by said handheld computer device in response to a query utilizing said information associated with said pre-printed optical code.

2. The system of claim 1 wherein said handheld computing device is a cell phone, smart phone, or tablet computer.

3. The system of claim 1 wherein said pre-printed optical code is provided as one or more stickers each with a pre-printed optical code wherein each sticker has a first side printed with said optical code and an opposite side having adhesive disposed thereon.

4. The system of claim 1 wherein said information captured by said handheld computer device is audio, video, text, web links, or combinations thereof.

5. The system of claim 1 wherein said optical code is a computer readable code selected from: a barcode, QR code, visible code; computer readable code visible only in an infrared light spectrum, computer readable code visible only in an ultraviolet light spectrum, or combinations thereof.

6. A system for personalized storage and retrieval of information, said system comprising:
a handheld computer device constructed and arranged to transmit and receive information wirelessly over the Internet and further constructed with a configuration for reading a QR code;
a mobile computing application operatively associated with said handheld computer device;
a pre-printed QR code on a computer readable surface;
information captured by said handheld computer device and associated with said pre-printed QR code;
a cloud-based information storage system constructed to receive said information captured by said handheld computer device and to transmit said information captured by said handheld computer device in response to a query utilizing said information associated with said pre-printed QR code.

7. The system of claim 1 wherein said handheld computing device is a cell phone, smart phone, or tablet computer.

8. The system of claim 1 wherein said pre-printed QR code is provided as one or more stickers each with a pre-printed QR code wherein each sticker has a first side printed with said QR code and an opposite side having adhesive disposed thereon.

9. The system of claim 1 wherein said information captured by said handheld computer device is audio, video, text, web links, or combinations thereof.

10. A method of storing and retrieving information, said method comprising the steps of:
providing a system of claim 1;
capturing information with said handheld computing device;
associating said captured information with a unique QR code utilizing said mobile computing application;
transmitting said associated information to a cloud-based storage device where said information is stored with said unique QR code;
retrieving said associated information from said cloud-based storage device by sending a query with said unique QR code to said cloud-based storage device and said retrieved information is transmitted to said handheld computer device.
